(19) United States
(12) Patent Application Publication
(10) Pub. No.: US 2012/0228080 A1
(43) Pub. Date: Sep. 13, 2012

(54) TRANSMISSION WITH HILL HOLD FEATURE

(75) Inventor: Simon Paul Fitzgerald, Kellyville (AU)

(73) Assignee: NT CONSULTING INTERNATIONAL PTY LIMITED, Castle Hill, New South Wales (AU)

(21) Appl. No.: 13/395,039

(22) PCT Filed: Sep. 6, 2010
(86) PCT No.: PCT/AU2010/001146

§ 371 Date: May 23, 2012

(30) Foreign Application Priority Data
Sep. 21, 2009 (AU) 2009904558

(51) Int. Cl. B60W 10/11

(52) U.S. Cl. 192/219.2

(57) ABSTRACT

An automotive transmission having a hill hold feature, comprising an input shaft arranged to be driven by an engine, an output shaft arranged to transfer drive from the input shaft to driving wheels of a vehicle to which the transmission is fitted, and a transmission housing within which the input and output shafts rotate, wherein a one-way clutch is coupled to the input shaft and the housing to allow rotation of the input shaft in only one direction relative to the housing, such that when a forward gear of the transmission is engaged the vehicle is prevented from rolling backward.

### FIELD OF THE INVENTION

This invention relates to an automotive transmission having a hill hold feature and, more particularly but not exclusively, to a double clutch transmission (DCT) having a hill hold feature which prevents rolling back of the vehicle when a forward gear is engaged, and prevents rolling forward of the vehicle when a reverse gear is engaged.

### BACKGROUND OF THE INVENTION

The applicant has determined that there is a need for preventing unwanted rolling of a vehicle. In particular, with conventional manual transmissions fitted to vehicles, when performing a hill start the driver selects a first forward gear ratio while applying a brake. The driver is then able to take off by simultaneously engaging the clutch as the brake is released. In order to perform a hill start of this kind in a conventional manual transmission vehicle it is necessary to use a hand brake of the vehicle.

However, for various reasons, many drivers do not perform hill starts using the hand brake, and instead attempt to quickly transfer their right foot from the foot brake to the accelerator. This practice can lead to the vehicle rolling backward prior to being driven forward, and can be dangerous, particularly if there is another vehicle close behind the vehicle in question. The applicant has determined that it would be desirable for there to be provided a transmission with a hill hold feature which automatically prevents a vehicle rolling backward when the first forward gear ratio is engaged.

With the relatively recent adoption of double clutch transmissions (DCTs), vehicles are being produced with automatically controlled manual transmissions. With these transmissions, the driver no longer has a pedal to manually control engagement of the clutch, and the vehicle may be subject to rolling backward on hills prior to application of the accelerator. The applicant has determined that it would be beneficial for there to be provided a double clutch transmission having a hill hold feature which prevents the vehicle from rolling backward prior to application of the accelerator. Furthermore, the applicant has determined that it would be advantageous if the hill hold feature were also able to function when reverse gear is engaged so as to prevent unwanted rolling forward of the vehicle prior to application of the accelerator.

Examples of the invention seek to solve, or at least ameliorate, one or more disadvantages of previous automotive transmissions.

### SUMMARY OF THE INVENTION

In accordance with one aspect of the present invention, there is provided an automotive transmission having a hill hold feature, comprising an input shaft arranged to be driven by an engine, an output shaft arranged to transfer drive from the input shaft to driving wheels of a vehicle to which the transmission is fitted, and a transmission housing within which the input and output shafts rotate, wherein a one-way clutch is coupled to the input shaft and the housing to allow rotation of the input shaft in only one direction relative to the housing, such that when a forward gear of the transmission is engaged the vehicle is prevented from rolling backward.

Preferably, the one-way clutch is arranged such that when a reverse gear of the transmission is engaged the vehicle is prevented from rolling forward.

Preferably, the transmission is a double clutch transmission, and the input shaft is arranged to transfer drive to the driving wheels in a 1^{st} forward gear of the transmission. More preferably, the input shaft is arranged to transfer drive to the driving wheels in odd-numbered forward gears of the transmission. Even more preferably, a second input shaft is arranged to transfer drive to the driving wheels in even-numbered forward gears of the transmission.

Preferably, the transmission includes a first clutch for coupling the first input shaft to the engine and a second clutch for coupling the second input shaft to the engine, wherein engagement of the first and second clutches is automatically controlled.

Preferably, the transmission includes a second output shaft arranged to transfer drive to the driving wheels when the reverse gear is engaged. More preferably, the transmission includes a reverse idler gear for transmitting drive from the first input shaft to the second output shaft, the reverse idler gear being arranged such that the second output shaft is driven in the same direction as the first input shaft.

In accordance with another aspect of the present invention, there is provided an automotive transmission having a hill hold feature, comprising an input shaft arranged to be driven by an engine, an output shaft arranged to transfer drive from the input shaft to driving wheels of a vehicle to which the transmission is fitted, and a transmission housing within which the input and output shafts rotate, wherein a one-way clutch is coupled to the input shaft and the housing to allow rotation of the input shaft in only one direction relative to the housing, such that when a reverse gear of the transmission is engaged the vehicle is prevented from rolling forward.

In accordance with another aspect of the present invention, there is provided an automotive transmission having a hill hold feature, comprising a first input shaft arranged to transmit drive from an engine to driving wheels of a vehicle in odd-numbered forward gears of the transmission, a second input shaft arranged to transmit drive from the engine to the driving wheels in even-numbered forward gears of the transmission, an output shaft arranged to transfer drive from one or both of the input shafts to the driving wheels, and a transmission housing within which the input and output shafts rotate, wherein a one-way clutch is coupled to the first input shaft and the housing to allow rotation of the first input shaft in only one direction relative to the housing, such that when a first forward gear of the transmission is engaged the vehicle is prevented from rolling backward.

### BRIEF DESCRIPTION OF THE DRAWINGS

The invention is described, by way of non-limiting example only, with reference to the accompanying drawings in which:

FIG. 1 is a diagrammatic view of an automotive transmission having a hill hold feature in accordance with an example of the present invention;

FIG. 2 shows power flow through the transmission when engaged in a first forward gear ratio; and

FIG. 3 shows power flow through the transmission when engaged in a reverse gear ratio.

### DETAILED DESCRIPTION

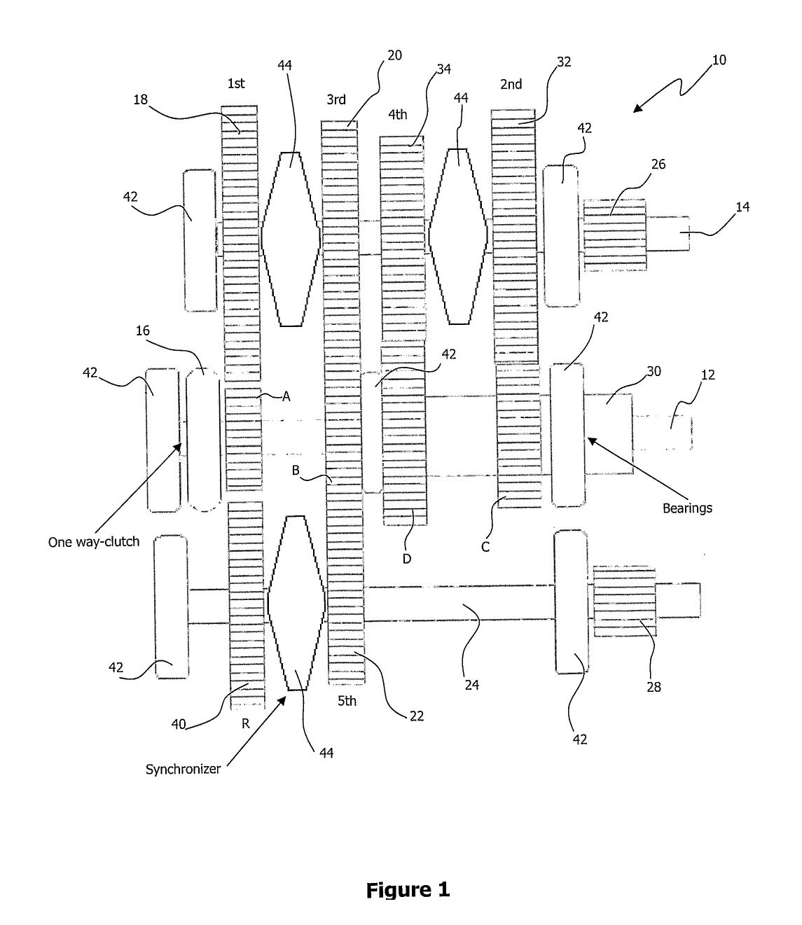

With reference to FIG. 1, there is shown an automotive transmission 10 having a hill hold feature, in accordance with an example of the present invention. The transmission 10 includes an input shaft 12 arranged to be driven by an engine (not shown), an output shaft 14 arranged to transfer drive from the input shaft 12 to driving wheels of a vehicle to which the transmission 10 is fitted, and a transmission housing within which the input shaft 12 and output shaft 14 rotate. A one-way clutch 16 is coupled to the input shaft 12 and the housing to allow rotation of the input shaft 12 in only one direction relative to the housing such that, when a forward gear of the transmission 10 is engaged, the vehicle is prevented from rolling backward.

Accordingly, the one-way clutch 16 allows the input shaft 12 to rotate in only one direction relative to the transmission housing such that, when the forward gear is engaged the vehicle is prevented from rolling backward. Specifically, prior to coupling of the input shaft 12 to the engine by way of the drive clutch, the vehicle would ordinarily be subject to rolling backward, however with the present arrangement such rolling backward of the vehicle is prevented by the one-way clutch 16. Referring to the features of the transmission shown in FIG. 1, rolling backward of the vehicle would cause the driving wheels of the vehicle to roll backward which, in turn, would cause the output shaft 14 to rotate in a reverse direction, and the input shaft 12 to rotate in a reverse direction. However, as the input shaft 12 is prevented from rotating in a reverse direction relative to the housing, such rolling backward of the vehicle is effectively prevented.

The one-way clutch 16 is preferably arranged such that when a reverse gear of the transmission 10 is engaged the vehicle is prevented from rolling forward. This is achieved in the example of the transmission 10 shown in FIGS. 1 to 3 by virtue of reverse gear of the transmission 10 using the same input shaft 12 as the 1^{st}, 3^{rd} and 5^{th} forward gears. Advantageously, as the input shaft 12 rotates in the same direction when driving the vehicle in the reverse gear as in the 1^{st}, 3^{rd} and 5^{th} forward gears, the one-way clutch 16 is also effective in preventing rolling forward of the vehicle when the reverse gear is engaged.

The transmission 10 is a double clutch transmission (DCT), and the input shaft 12 is arranged to transfer drive to the driving wheels in odd-numbered forward gears of the transmission 10 (ie. 1^{st}, 3^{rd} and 5^{th} forward gears). This is achieved by the input shaft 12 having one gear (gear “A”) which transmits drive from the input shaft 12 to a 1^{st} ratio gear 18, and another gear (gear “B”) for transmitting drive from the input shaft 12 to a 3^{rd} ratio gear 20 and a 5^{th} ratio gear 22. The 1^{st} ratio gear 18 and 3^{rd} ratio gear 20 are mounted on output shaft 14, whereas the 5^{th} ratio gear 22 is mounted on a second output shaft 24. Power is transmitted from the first output shaft 14 to the driving wheels by first output pinion 26, and power is transmitted from the second output shaft to the driving wheels by a second output pinion 28.

A second input shaft 30 is fitted in sleeved arrangement about the first input shaft 12, and is arranged to transfer drive to the driving wheels in even-numbered forward gears of the transmission 10 (ie. in 2^{nd} and 4^{th} forward gear ratios of the transmission).

This is achieved by way of the second input shaft 30 having one gear (gear “C”) for transmitting drive to a 2^{nd} ratio gear 32, and another gear (gear “D”) for transmitting drive to a 4^{th} ratio gear 34. The 2^{nd} gear ratio 32 and the 4^{th} gear ratio 34 are mounted on the first output shaft 14, such that power is transmitted to the driving wheels in the 2^{nd} and 4^{th} forward gear ratios via the first output pinion 26.

A first clutch is used for coupling the first input shaft 12 to the engine, and a second clutch is used for coupling the second input shaft 30 to the engine, with engagement of the first and second clutches being automatically controlled.

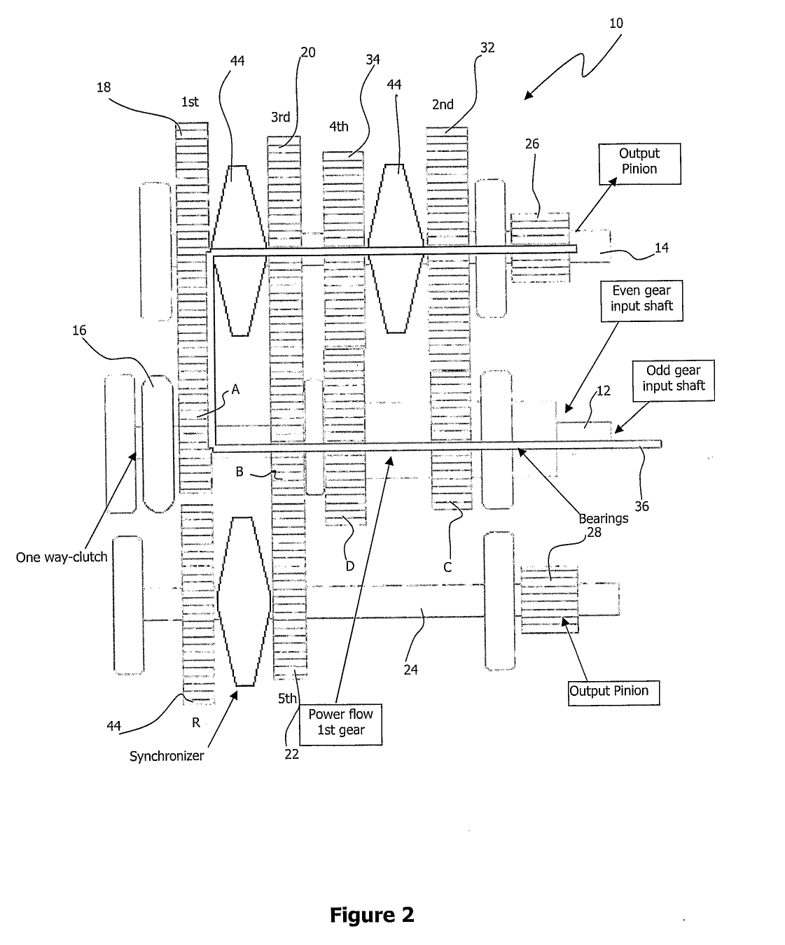

With reference to FIG. 2, when the transmission 10 is engaged in the 1^{st} forward gear ratio, power flows through the transmission 10 along line 36. As can be seen, power from the engine is transmitted to the first input shaft 12, from where power flows via gear A to the 1^{st} ratio gear 18, then along the first output shaft 14. Power is fed from the first output shaft 14 to the driving wheels of the vehicle through the first output pinion 26. Rolling backward of the vehicle in this gear state is prevented by virtue of the same power flow path which results in the one-way clutch 16 locking in order to prevent rolling back of the vehicle.

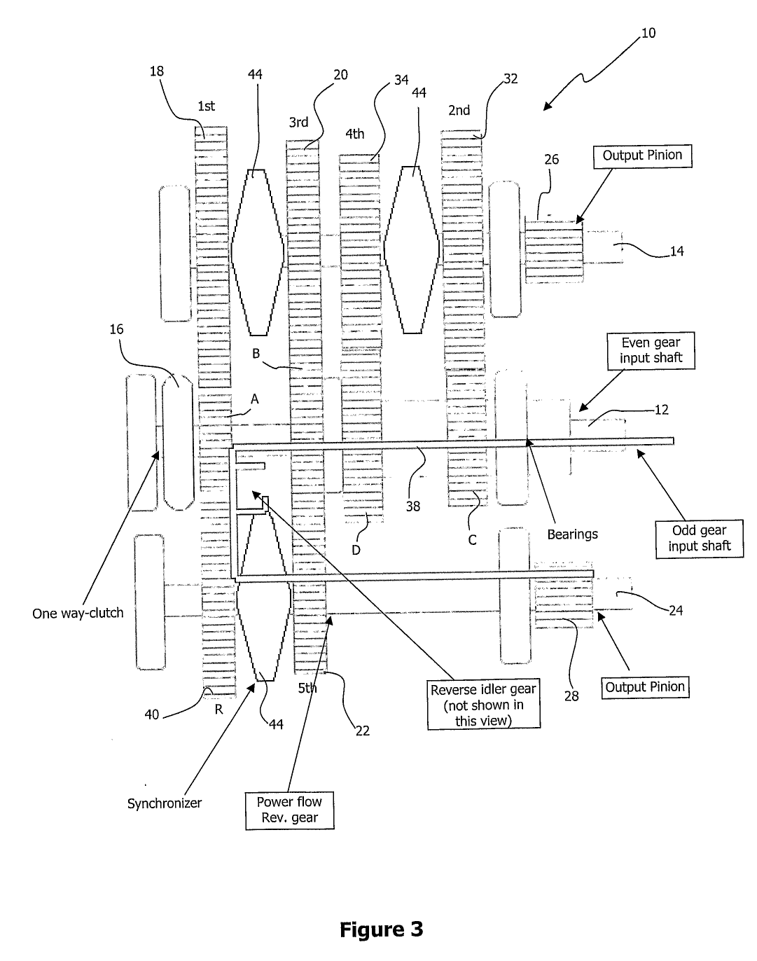

With reference to FIG. 3, there is shown a power flow diagram depicting flow of power through the transmission 10 when engaged in the reverse gear. Power flow is transmitted along line 38 along the first input shaft 12 to gear “A”, from where power is transmitted via a reverse idler gear to a reverse ratio gear 40. The reverse ratio gear 40 is mounted on the second output shaft 24, and power flows along the second output shaft 24 from where it is fed to the driving wheels of the vehicle by the second output pinion 28. By virtue of the reverse idler gear, the first input shaft 12 rotates in the same direction regardless of whether the transmission 10 is in the 1^{st} forward gear ratio or the reverse gear ratio, facilitating the use of the same one-way clutch 16 to prevent rolling backwards in the 1^{st} forward gear ratio and rolling forwards in the reverse gear ratio.

Each of the shafts is provided with a plurality of bearings 42 to facilitate rotation of the shafts relative to the transmission housing, and the two output shafts 14, 24 are provided with synchronizers 44 to facilitate synchronization of rotational speed of the output shafts 14, 24.

Although the embodiment depicted in the drawings shows a DCT with reverse and 1^{st} gears on the same input shaft 12, it will be appreciated by those skilled in the art that other examples of the present invention may involve reverse and 1^{st} gears having separate input shafts, in which case the hill hold functionality may be provided in only the 1^{st} forward gear ratio.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. An automotive transmission having a hill hold feature, comprising an input shaft arranged to be driven by an engine, an output shaft arranged to transfer drive from the input shaft to driving wheels of a vehicle to which the transmission is fitted, and a transmission housing within which the input and output shafts rotate, wherein a one-way clutch is coupled to the input shaft and the housing to allow rotation of the input shaft in only one direction relative to the housing, such that when a forward gear of the transmission is engaged the vehicle is prevented from rolling backward.

2. An automotive transmission as claimed in claim 1, wherein the one-way clutch is arranged such that when a reverse gear of the transmission is engaged the vehicle is prevented from rolling forward.

3. An automotive transmission as claimed in claim 1, wherein the transmission is a double clutch transmission, and the input shaft is arranged to transfer drive to the driving wheels in a first forward gear of the transmission.

4. An automotive transmission as claimed in claim 3, wherein the input shaft is arranged to transfer drive to the driving wheels in odd-numbered forward gears of the transmission.

5. An automotive transmission as claimed in claim 4, wherein a second input shaft is arranged to transfer drive to the driving wheels in even-numbered forward gears of the transmission.

6. An automotive transmission as claimed in claim 4, further comprising a first clutch for coupling the input shaft to the engine and a second clutch for coupling the second input shaft to the engine, wherein engagement of the first and second clutches is automatically controlled.

7. An automotive transmission as claimed in claim 2, further comprising a second output shaft arranged to transfer drive to the driving wheels when the reverse gear is engaged.

8. An automotive transmission as claimed in claim 7, further comprising a reverse idler gear for transmitting drive from the input shaft to the second output shaft, the reverse idler gear being arranged such that the second output shaft is driven in the same direction as the input shaft.

9. An automotive transmission having a hill hold feature, comprising an input shaft arranged to be driven by an engine, an output shaft arranged to transfer drive from the input shaft to driving wheels of a vehicle to which the transmission is fitted, and a transmission housing within which the input and output shafts rotate, wherein a one-way clutch is coupled to the input shaft and the housing to allow rotation of the input shaft in only one direction relative to the housing, such that when a reverse gear of the transmission is engaged the vehicle is prevented from rolling forward.

10. An automotive transmission having a hill hold feature, comprising a first input shaft arranged to transmit drive from an engine to driving wheels of a vehicle in odd-numbered forward gears of the transmission, a second input shaft arranged to transmit drive from the engine to the driving wheels in even-numbered forward gears of the transmission, an output shaft arranged to transfer drive from one or both of the input shafts to the driving wheels, and a transmission housing within which the input and output shafts rotate, wherein a one-way clutch is coupled to the first input shaft and the housing to allow rotation of the first input shaft in only one direction relative to the housing, such that when a first forward gear of the transmission is engaged the vehicle is prevented from rolling backward.

11. (canceled)

12. An automotive transmission as claimed in claim 5, further comprising a first clutch for coupling the input shaft to the engine and a second clutch for coupling the second input shaft to the engine, wherein engagement of the first and second clutches is automatically controlled.

13. An automotive transmission as claimed in claim 2, wherein the transmission is a double clutch transmission, and the input shaft is arranged to transfer drive to the driving wheels in a first forward gear of the transmission.

14. An automotive transmission as claimed in claim 13, further comprising a second output shaft arranged to transfer drive to the driving wheels when the reverse gear is engaged.

15. An automotive transmission as claimed in claim 13, wherein the input shaft is arranged to transfer drive to the driving wheels in odd-numbered forward gears of the transmission.

16. An automotive transmission as claimed in claim 15, further comprising a second output shaft arranged to transfer drive to the driving wheels when the reverse gear is engaged.

17. An automotive transmission as claimed in claim 15, further comprising a first clutch for coupling the input shaft to the engine and a second clutch for coupling the second input shaft to the engine, wherein engagement of the first and second clutches is automatically controlled.

18. An automotive transmission as claimed in claim 15, wherein a second input shaft is arranged to transfer drive to the driving wheels in even-numbered forward gears of the transmission.

19. An automotive transmission as claimed in claim 18, further comprising a second output shaft arranged to transfer drive to the driving wheels when the reverse gear is engaged.

20. An automotive transmission as claimed in claim 18, further comprising a first clutch for coupling the input shaft to the engine and a second clutch for coupling the second input shaft to the engine, wherein engagement of the first and second clutches is automatically controlled.

21. An automotive transmission as claimed in claim 20, further comprising a second output shaft arranged to transfer drive to the driving wheels when the reverse gear is engaged.
